(19) United States
(12) Patent Application Publication
(10) Pub. No.: US 2016/0040450 A1
(43) Pub. Date: Feb. 11, 2016

(54) HANDLE APPARATUS AND RETURN MECHANISM THEREIN

(71) Applicant: TAIWAN FU HSING INDUSTRIAL CO., LTD., Kaohsiung City (TW)

(72) Inventors: Jiun-Nan Shiu, Kaohsiung City (TW); Shih-Min Lu, Kaohsiung City (TW)

(21) Appl. No.: 14/541,250

(22) Filed: Nov. 14, 2014

(30) Foreign Application Priority Data
Aug. 6, 2014 (TW) 103126997

(51) Int. Cl. E05B 1/00; E05B 3/00

(52) U.S. Cl. CPC E05B 1/003; E05B 3/00

(57) ABSTRACT

A handle apparatus comprises a case, a first positioning base, a second positioning base, a handle and a return mechanism. The return mechanism is engaged with the handle. The first positioning base and the second positioning base are disposed at the case. A positioning plate of the return mechanism optionally engages with the first positioning base or the second positioning base for making the handle apparatus optionally disposed at a left-hand swing door or a right-hand swing door.

### FIELD OF THE INVENTION

The present invention is generally relating to a handle apparatus and a return mechanism therein. Particularly, the handle apparatus and the return mechanism therein are optionally disposed at a left-hand swing door or a right-hand swing door in accordance with usage environment.

### BACKGROUND OF THE INVENTION

In prior art, one lateral side of a door plate is pivotally mounted to a wall (or pillar) for making the door plate open toward the left side or the right side. The door plate can be distinguished into a left-hand swing door and a right-hand swing door by the opening direction of the door plate. With reference to FIG. 10, Taiwan Utility Model application number 097205865 discloses “Fixedly disposing a fixing base 7 at bottom side of a penetration hole of a door case 1, a blocking plate 71 is disposed and protruded to the fixing base 7, two coupling plates 72 are disposed at two bending sides of the blocking plate 71 respectively, wherein a screw bolt 8 is locked and disposed at one of the coupling plates 72 according to user demand, and a torsion terminal 41 of a torsion spring 4 is limited between the blocking plate 71 of the fixing base 7 and the screw bolt 8”. The lockset can be applied to the left-hand swing door or the right-hand swing door in the Taiwan Utility Model application number 097205865. However, owing to the torsion terminal 41 of the torsion spring 4 limited between the blocking plate 71 and the screw bolt 8, the torsion terminal 41 of the torsion spring 4 will depart from the blocking plate 71 therefore causing the torsion spring 4 to be unable to drive a rotation plate 5 when a handle 2 is pushed down too much. Accordingly, the handle 2 cannot return to its original position. Besides, the torsion terminal 41 must be limited between the blocking plate 71 and the screw bolt 8 precisely, or the door lock will be malfunctioned.

Taiwan Utility Model application number 092214994 discloses “A screw hole is located under the base to lock a blocking plate, a positioning blade of a rotated blocking plate is blocked by the blocking plate to limit the swing amplitude of a handle. A sliding slot is disposed at top side of a screw hole of the blocking plate for a screw bolt to lock up, wherein the screw bolt comprises a tapered threaded-rod section. When the screw bolt is loose, the blocking plate enables to move downward to release the rotated blocking plate from the position limit by the blocking plate to adjust the operation direction of the handle. After the adjustment, the blocking plate is moved upward for fixedly locked up and regains the limit function of the swing amplitude of the handle”. The lockset can be applied to the left-hand swing door or the right-hand swing door in the mentioned invention. However, owing to the screw hole of the blocking plate communicated with the sliding slot, once the screw bolt is fixed inappropriately, the blocking plate slides downward and unable to limit one end of a spring to drive the rotated blocking plate. Accordingly, the handle cannot return to its original position.

### SUMMARY

The primary object of the present invention is to provide a handle apparatus including a case, a first positioning base, a second positioning base, a handle and a return mechanism. The case has an accommodating space, the first positioning base and the second positioning base are engaged with the case, the handle comprises a transmission shaft, and the handle is pivotally connected to the case by the transmission shaft. The transmission shaft penetrates through the case and disposed within the accommodating space, the return mechanism is disposed within the accommodating space and includes a positioning plate having a main body, a blocking member and a positioning member. The blocking member and the positioning member are disposed at the main body respectively, wherein the positioning member of the positioning plate is optionally engaged with the first positioning member or the second positioning member.

The other object of the present invention is to provide a return mechanism of the handle apparatus including a positioning plate, a driving plate and an elastic unit. The positioning plate comprises a main body, a blocking member and a positioning member, wherein the blocking member and the positioning member are disposed at the main body respectively, and the driving plate comprises a base, a driving member and at least one engaging member. The driving member and the at least one engaging member are disposed at the base, the elastic unit comprises a first end portion and a second end portion, the first end portion contacts with the blocking member of the positioning plate, the second end portion contacts with the driving member of the driving plate, wherein the positioning member of the positioning plate is optionally engaged with a first positioning base or a second positioning base.

By the positioning member of the positioning plate optionally engaged with the first positioning base or the second positioning base, the present invention of the handle apparatus enables to be applied to a left-hand swing door or a right-hand swing door, and prevents the handle from unavailable return because the elastic unit is unable to drive the driving plate.

### DESCRIPTION OF THE DRAWINGS

FIG. 1 is a perspective assembly drawing illustrating a handle apparatus of the present invention.

FIG. 2 is a perspective exploded drawing illustrating the handle apparatus of the present invention.

FIG. 3 is a back view assembly drawing illustrating the handle apparatus mounted at a left-hand swing door in accordance with the present invention.

FIG. 4 is a back view operating assembly drawing illustrating the handle apparatus mounted at the left-hand swing door in accordance with the present invention.

FIG. 5 is a back view assembly drawing illustrating the handle apparatus mounted at a right-hand swing door in accordance with the present invention.

FIG. 6 is a back view operating assembly drawing illustrating the handle apparatus mounted at the right-hand swing door in accordance with the present invention.

FIG. 7 is a perspective explored drawing illustrating an auxiliary return plate and a driving plate of the present invention.

FIGS. 8 to 9 are perspective assembly drawings illustrating the auxiliary return plate and the driving plate of the present invention.

FIG. 10 is a back view assembly drawing of Taiwan Utility Model application number 097205865.

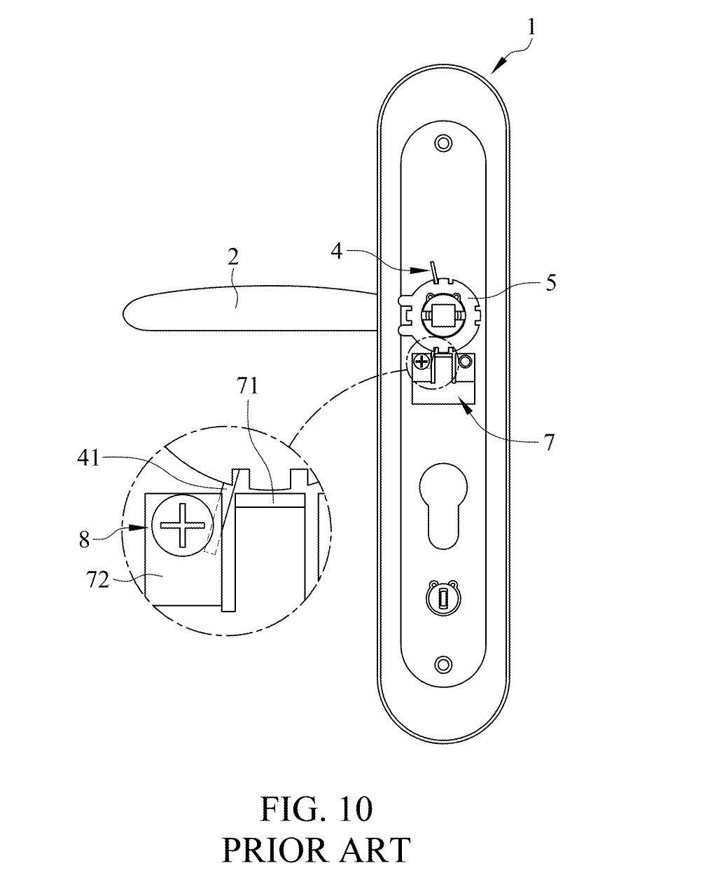

### DETAILED DESCRIPTION OF THE INVENTION

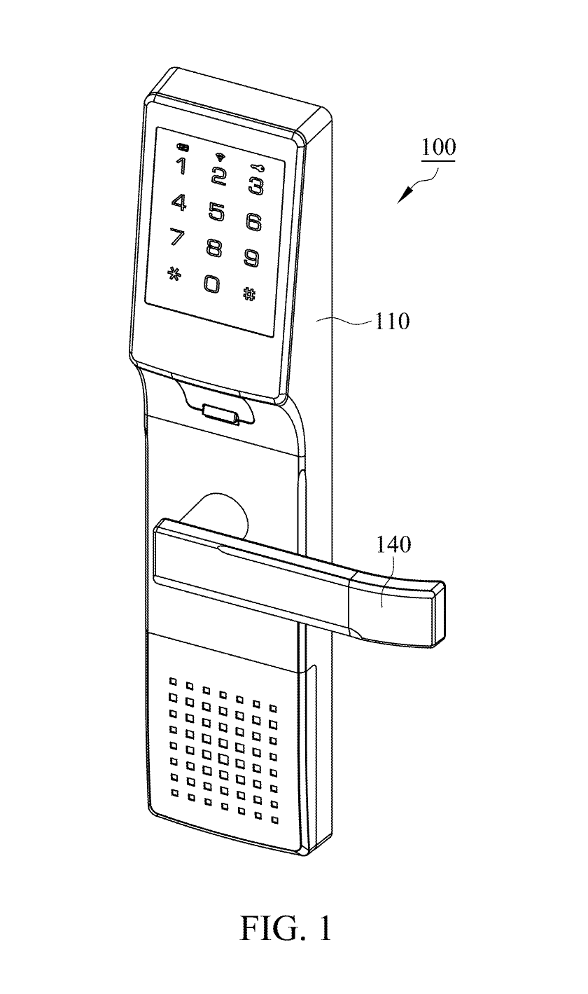

With reference to FIGS. 1, 2, 3 and 4, a handle apparatus 100 of an embodiment of the present invention is illustrated. The handle apparatus 100 enables to mount at left side or right side of a door plate according to the open direction of the door plate. That means the handle apparatus 100 is optionally mounted at the door plate of a left-hand swing door or a right-hand swing door.

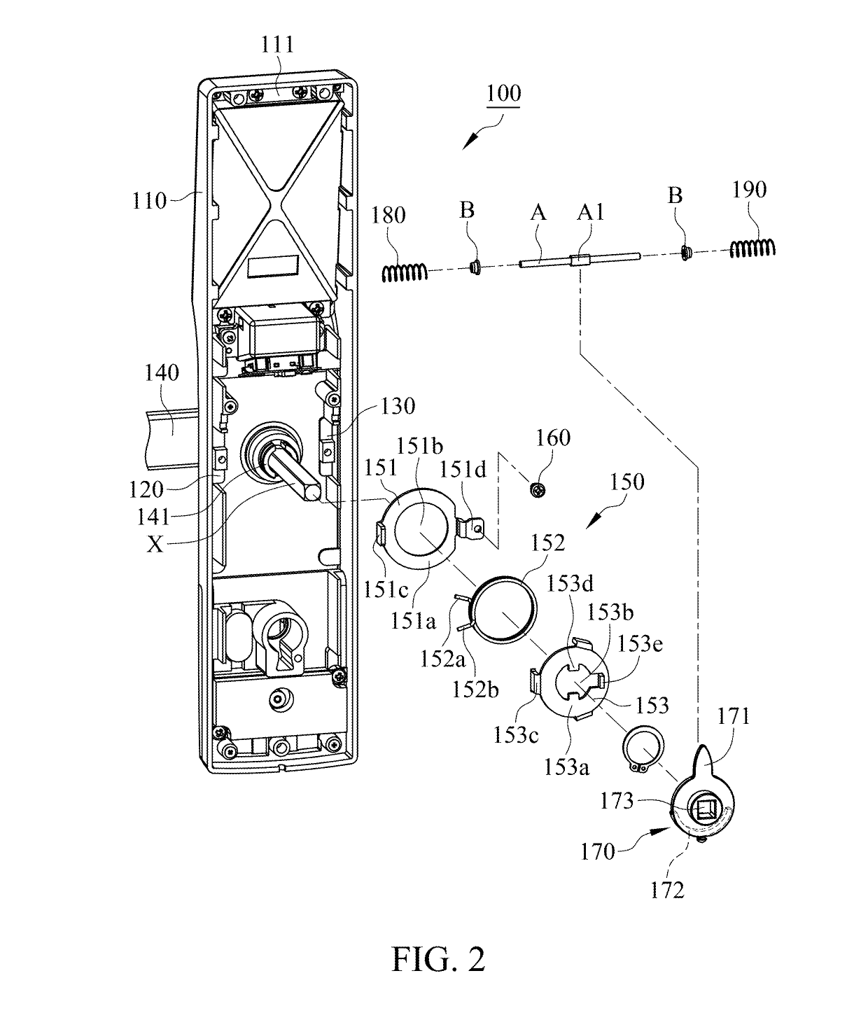

With reference to FIG. 2, the handle apparatus 100 includes a case 110 and a handle 140 which pivotally connected to the case 110. In this embodiment, the case 110 has an accommodating space 111, the handle 140 comprises a transmission shaft 141, the handle 140 is pivotally connected to the case 110 by the transmission shaft 141, and the transmission shaft 141 penetrates through and disposed within the accommodating space 111.

With reference to FIG. 2, the handle apparatus 100 further includes a first positioning base 120, a second positioning base 130 and a return mechanism 150, wherein the first positioning base 120 and the second positioning base 130 are engaged with the case 110. In this embodiment, the first positioning base 120 and the second positioning base 130 are disposed in the accommodating space 111. Preferably, the first positioning base 120, the second positioning base 130 and the case 110 are formed as one piece, and the first positioning base 120 and the second positioning base 130 are disposed at two sides of the transmission shaft 141 respectively.

With reference to FIG. 2, the return mechanism 150 is disposed within the accommodating space 111 and includes a positioning plate 151, a first elastic unit and a driving plate 153, wherein the positioning plate 151 comprises a main body 151a, a blocking member 151c and a positioning member 151d. The blocking member 151c and the positioning member 151d are disposed at the main body 151a respectively, and the positioning member 151d of the positioning plate 151 is optionally engaged with the first positioning base 120 or the second positioning base 130. In this embodiment, the positioning plate 151 comprises a pivoting hole 151b penetrated through the main body 151a, the transmission shaft 141 of the handle 140 penetrates through the pivoting hole 151b of the positioning plate 151 to make the positioning plate 151 rotating on the transmission shaft 141 as center in favor of the positioning member 151d optionally engaged with the first positioning base 120 or the second positioning base 130.

With reference to FIG. 2, the driving plate 153 comprises a base 153a, a driving member 153c and at least one engaging member 153d, the driving member 153c and the engaging member 153d are disposed at the base 153a, and the driving plate 153 is pivotally connected to the transmission shaft 141 of the handle 140. In this embodiment, the driving plate 153 comprises a first perforation 153b penetrated through the base 153a, and the transmission shaft 141 of the handle 140 penetrates through the first perforation 153b of the driving plate 153, and the engaging member 153d of the driving plate 153 is engaged with the transmission shaft 141 of the handle 140. When the handle 140 is turned, the transmission shaft 141 of the handle 140 drives the driving plate 153 to rotate simultaneously by the engaging member 153d.

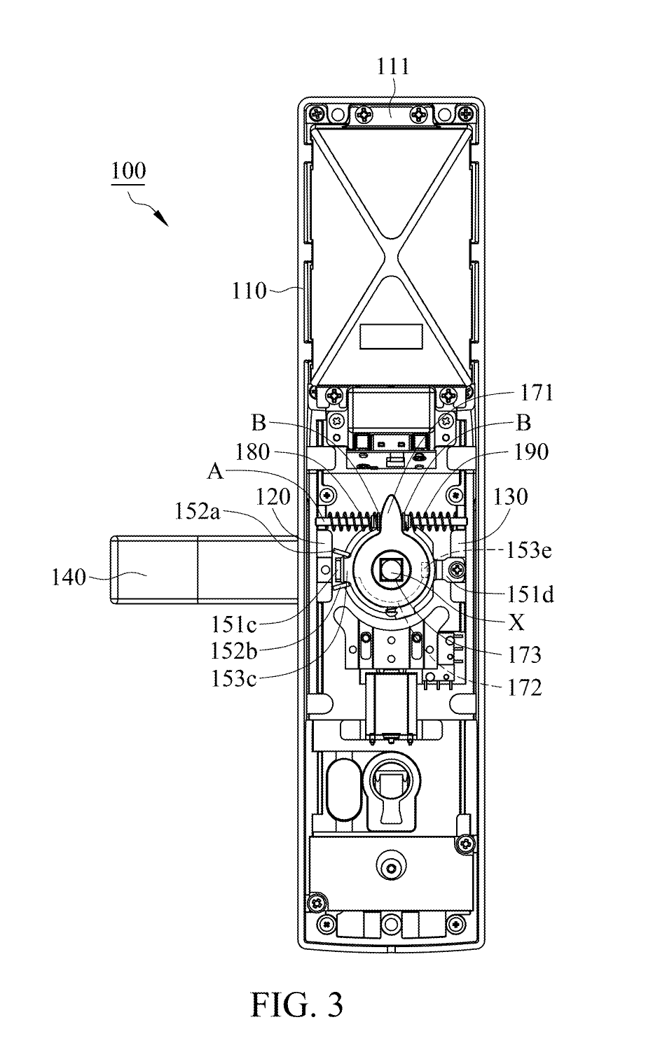

Referring to FIGS. 2 and 3, the first elastic unit 152 comprises a first end portion 152a and a second end portion 152b, the first end portion 152a of the first elastic unit 152 contacts with the blocking member 151c of the positioning member 151, and the second end portion 152b of the first elastic unit 152 contacts with the driving member 153c of the driving plate 153. In this embodiment, the blocking member 151c and the driving member 153c are disposed between the first end portion 152a and the second end portion 152b of the first elastic unit 152, wherein the first elastic unit 152 is a torsion spring.

Referring to FIGS. 2, 3 and 4, the handle apparatus 100 mounted at the left-hand swing door is illustrated by mentioned diagrams. The positioning member 151d of the positioning plate 151 engages with the second positioning base 130. When the handle 140 is turned, the transmission shaft 141 of the handle 140 drives an unlatch rod X to rotate for unlatching a latch bolt of a lock set. Simultaneously, the transmission shaft 141 also drives the driving plate 153 to rotate.

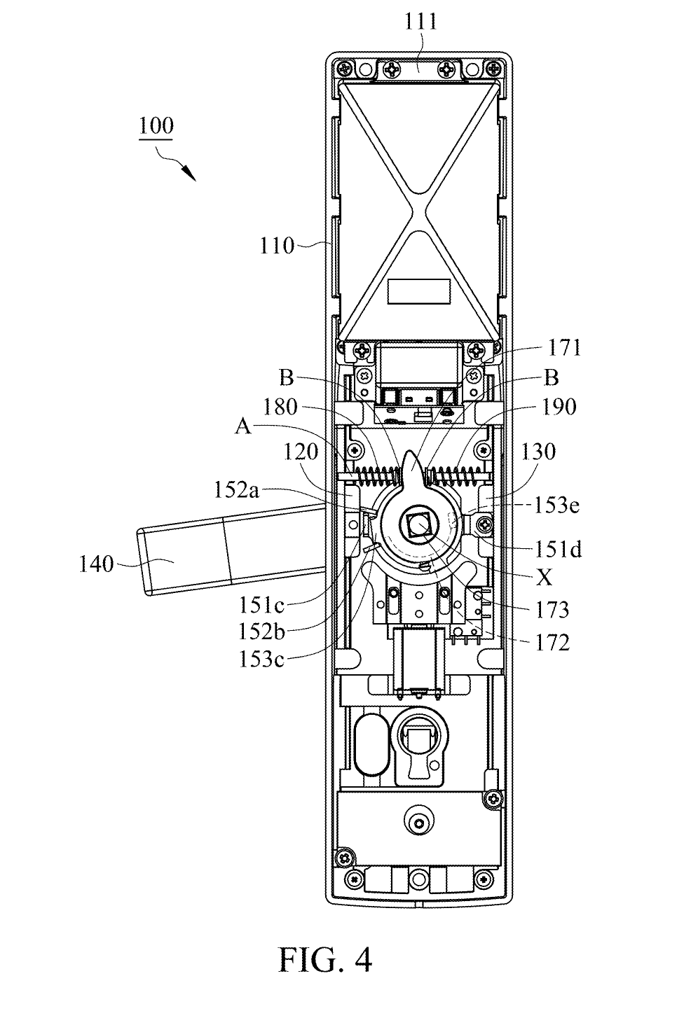

With reference to FIGS. 3 and 4, the positioning member 151d of the positioning plate 151 is engaged with the second positioning base 130. The location of the first end portion 152a of the first elastic unit 152 is limited by the blocking member 151c of the positioning plate 151. Owing to the features mentioned above, when the driving plate 153 is rotated, the driving member 153c of the driving plate 153 will move from a first position (see FIG. 3) to a second position (see FIG. 4). The driving member 153c of the driving plate 153 pushes the second end portion 152b of the first elastic unit 152 to make the first elastic unit 152 generate a return elasticity. Comparatively, when the handle 140 is returned, the return elasticity generated from the first elastic unit 152 enables the second end portion 152b of the first elastic unit 152 to push the driving member 153c of the driving plate 153 therefore making the driving member 153c return to the first position (see FIG. 3) from the second position (see FIG. 4). Simultaneously, the driving plate 153 drives the transmission shaft 141 and the unlatch rod X to rotate for making the handle 140 and the latch bolt return to original position.

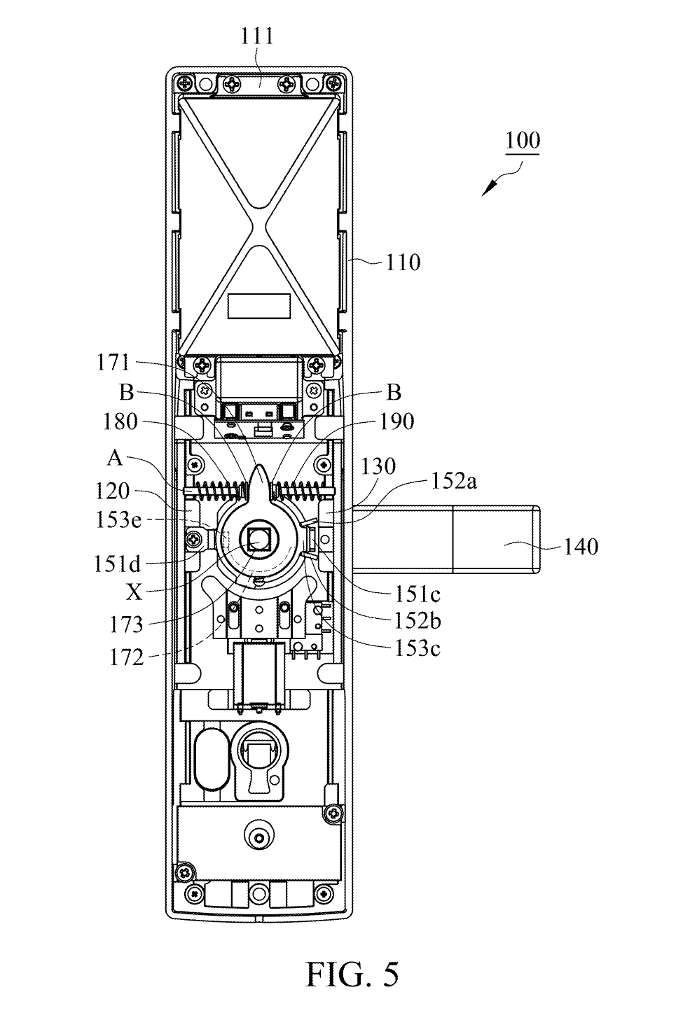

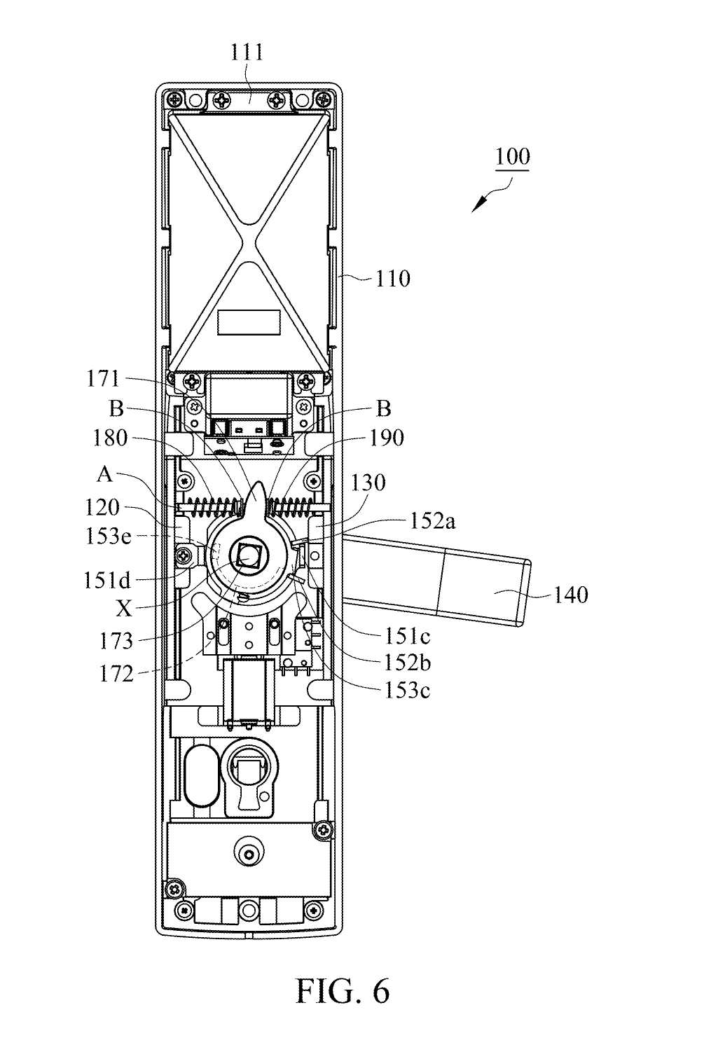

Referring to FIGS. 5 and 6, the handle apparatus 100 mounted at the right-hand swing door is illustrated by mentioned diagrams. When the handle apparatus 100 has to mount at the right-hand swing door in need, the positioning member 151d of the positioning plate 151 needs to move from the second positioning base 130 to the first positioning base 120. After that, the handle apparatus 100 can be applied to the right-hand swing door once the positioning member 151d of the positioning plate 151 is engaged with the first positioning base 120.

Referring to FIGS. 2, 3 and 5, the handle apparatus 100 further includes a fixing member 160. In this embodiment, the fixing member 160 is a screw bolt. The fixing member 160 penetrates through the positioning member 151d of the positioning plate 151 and engages with the first positioning base 120 or the second positioning base 130 for making the positioning member 151d fixed at the first positioning base 120 or the second positioning base 130.

Referring to FIG. 2, the handle apparatus 100 further includes an auxiliary return plate 170, a second elastic unit 180, a third elastic unit 190, a rod A and at least one spacing member B, wherein the rod A comprises a protruding portion A1. The second elastic unit 180 and the third elastic unit 190 are disposed at the rod A and located at two sides of the protruding portion A1 respectively. The rod A is engaged with the case 110. The auxiliary return plate 170 comprises a first bearing portion 171, a pushing portion 172 and a second perforation 173 corresponded to the first perforation 153b of the driving plate 153. In this embodiment, the unlatch rod X penetrates through the second perforation 173 and drives the auxiliary return plate 170 to rotate. The pushing portion 172 protrudes to the auxiliary return plate 170 and located between the driving plate 153 and the auxiliary return plate 170. The second elastic unit 180 and the third elastic unit 190 are used for pushing the first bearing portion 171 of the auxiliary return plate 170.

With reference to FIGS. 2 and 3, the first pushing portion 171 of the auxiliary return plate 170 is located between the second elastic unit 180 and the third elastic unit 190. In this embodiment, the spacing member B is disposed between the second elastic unit 180 and the first bearing portion 171 and located between the protruding portion A1 of the rod A and the second elastic unit 180. Or, the spacing member B enables to dispose between the third elastic unit 190 and the first bearing portion 171. The second elastic unit 180 or the third elastic unit 190 is used for pushing the spacing member B to push the first bearing portion 171 of the auxiliary return plate 170.

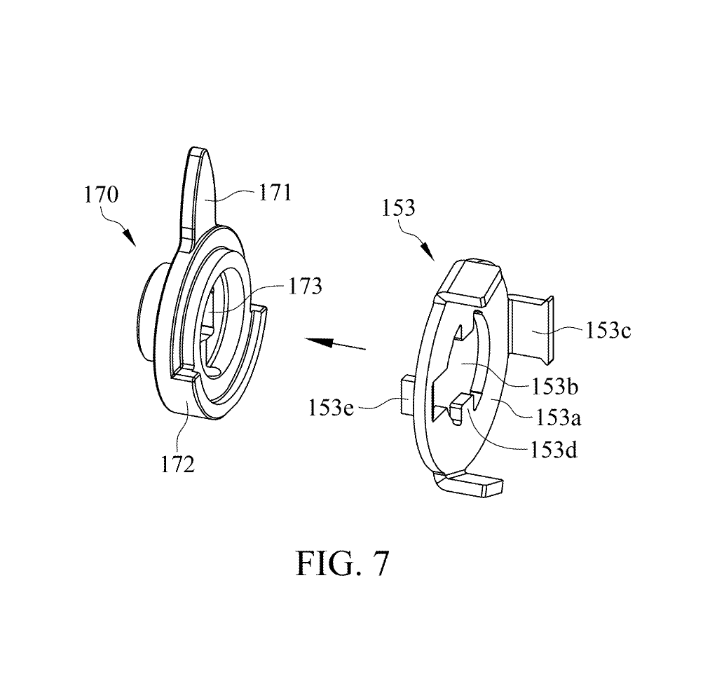

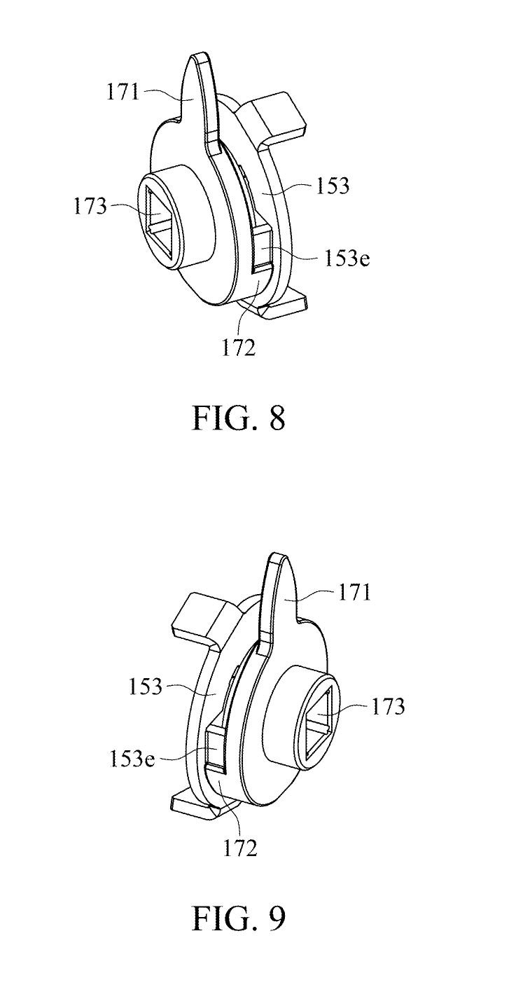

With reference to FIGS. 2, 7 and 8, the driving plate 153 further comprises a second bearing portion 153e protruded to the driving plate 153 and located between the driving plate 153 and the auxiliary return plate 170. The pushing portion 172 of the auxiliary return plate 170 is used for pushing the second bearing portion 153e of the driving plate 153.

Referring to FIGS. 2, 4 and 8, the handle apparatus 100 is mounted at the left-hand swing door. When the handle 140 is turned, the transmission shaft 141 of the handle 140 drives the unlatch rod X to rotate, and the unlatched rod X drives the auxiliary return plate 170 to swing simultaneously. Afterwards, the pushing portion 172 of the auxiliary return plate 170 pushes the second bearing portion 153e of the driving plate 153, and the first bearing portion 171 of the auxiliary return plate 170 pushes the spacing member B and the second elastic unit 180 for making the second elastic unit 180 generate the return elasticity. When the handle 140 is returned, the second bearing portion 153e of the driving plate 153 pushes the pushing portion 172 of the auxiliary return plate 170, and the second elastic unit 180 pushes the first bearing portion 171 of the auxiliary return plate 170 simultaneously for making the auxiliary return plate 170 swing back. The swing-back auxiliary return plate 170 drives the unlatch rod X to rotate to the right position.

With reference to FIGS. 5, 6 and 9, the handle apparatus 100 is mounted at the right-hand swing door. Likewise for the handle apparatus 100 mounted at the left-hand swing door, when the handle 140 is returned, the second bearing portion 153e of the driving plate 153 pushes the pushing portion 172 of the auxiliary return plate 170, simultaneously, the third elastic unit 190 pushes the first bearing portion 171 of the auxiliary return plate 170 for making the auxiliary return plate 170 swing back. The swing-back auxiliary return plate 170 drives the unlatch rod X to rotate to the right position.

With reference to FIGS. 4 and 6, when the first elastic unit 152 is under an elastic fatigue condition, or the interval between the first end portion 152a of the first elastic unit 152 and the blocking member 151c of the positioning plate 151 is too wide, or the interval between the second end portion 152b of the first elastic unit 152 and the driving member 153c of the driving plate 153 is too wide, the second elastic unit 180 or the third elastic unit 190 are used to push the first bearing portion 171 of the auxiliary return plate 170 to support the auxiliary return plate 170 for driving the unlatch rod X to turn to the right position therefore preventing the handle 140 from inclination. In a better embodiment, the second elastic unit 180 or the third elastic unit 190 is a compression spring or a flat spring. The problem for potential elastic fatigue of the first elastic unit 152 (torsion spring) is resolved by the easy disposition of the second elastic unit 180 and the third elastic unit 190.

While this invention has been particularly illustrated and described in detail with respect to the preferred embodiments thereof, it will be clearly understood by those skilled in the art that is not limited to the specific features shown and described and various modified and changed in form and details may be made without departing from the spirit and scope of this invention.

What is claimed is:

1. A handle apparatus includes:
a case having an accommodating space;
a first positioning base engaged with the case;
a second positioning base engaged within the case;
a handle having a transmission shaft pivotally mounted at the case, wherein the transmission shaft penetrates through the case and disposed within the accommodating space; and
a return mechanism disposed within the accommodating space, wherein the return mechanism includes a positioning plate having a main body, a blocking member and a positioning member, the blocking member and the positioning member are disposed at the main body respectively, the positioning member of the positioning plate is optionally engaged with the first positioning base or the second positioning base.

2. The handle apparatus in accordance with claim 1, wherein the return mechanism further includes a driving plate and a first elastic unit, the first elastic unit comprises a first end portion and a second end portion, the driving plate comprises a base, a driving member and at least one engaging member, the driving member and the engaging member are disposed at the base, the driving plate is pivotally mounted on the transmission shaft of the handle, the at least one engaging member of the driving plate is engaged with the transmission shaft of the handle for making the driving plate and the transmission shaft rotate simultaneously, the first end portion of the first elastic unit contacts with the blocking member of the positioning plate, and the second end portion of the first elastic unit contacts with the driving member of the driving plate.

3. The handle apparatus in accordance with claim 1 further includes a fixing member, wherein the positioning member is optionally engaged with the first positioning base or the second positioning base by the fixing member.

4. The handle apparatus in accordance with claim 1, wherein the first positioning base, the second positioning base and the case are formed as one piece.

5. The handle apparatus in accordance with claim 2, wherein the positioning plate comprises a pivoting hole penetrated through the main body, the driving plate comprises a first perforation penetrated through the base, and the transmission shaft of the handle penetrates through the pivoting hole of the positioning plate and the first perforation of the driving plate.

6. The handle apparatus in accordance with claim 1 further includes an auxiliary return plate and a second elastic unit, the auxiliary return plate comprises a first bearing portion and a pushing portion, the second elastic unit is used to push the first bearing portion of the auxiliary return plate.

7. The handle apparatus in accordance with claim 6, wherein the driving plate further includes a second bearing portion, the pushing portion of the auxiliary return plate pushes the second bearing portion of the driving plate.

8. The handle apparatus in accordance with claim 7, wherein the pushing portion of the auxiliary return plate protrudes to the auxiliary return plate, and the pushing portion is located between the driving plate and the auxiliary return plate.

9. The handle apparatus in accordance with claim 7, wherein the second bearing portion of the driving plate protrudes to the driving plate, and the second bearing portion is located between the driving plate and the auxiliary return plate.

10. The handle apparatus in accordance with claim 6, wherein the auxiliary return plate comprises a second perforation corresponded to the first perforation of the driving plate.

11. The handle apparatus in accordance with claim 6 further includes a third elastic unit, wherein the third elastic unit is used to push the first bearing portion of the auxiliary return plate to push the auxiliary return plate to rotate, and the first bearing portion of the auxiliary return plate is located between the second elastic unit and the third elastic unit.

12. The handle apparatus in accordance with claim 11 further includes a rod engaged with the case, wherein the second elastic unit and the third elastic unit are disposed at the rod.

13. The handle apparatus in accordance with claim 12 further includes a spacing member, wherein the second elastic unit pushes the spacing member to push the first pushing portion of the auxiliary return plate.

14. The handle apparatus in accordance with claim 13, wherein the rod comprises a protruding portion, the second elastic unit and the third elastic unit are located at two sides of the protruding portion respectively, and the spacing member is located between the protruding portion and the second elastic unit.

15. A return mechanism of a handle apparatus includes:
a positioning plate having a main body, a blocking member and a positioning member, wherein the blocking member and the positioning member are disposed at the main body respectively;
a driving plate having a base, a driving member and at least one engaging member, wherein the driving member and the at least one engaging member are disposed at the base; and
an elastic unit having a first end portion and a second end portion, wherein the first end portion contacts with the blocking member of the positioning plate, the second end portion contacts with the driving member of the driving plate, wherein the positioning member of the positioning plate is optionally engaged with a first positioning base or a second positioning base.
